(19) United States
(12) Patent Application Publication
(10) Pub. No.: US 2023/0231688 A1
(43) Pub. Date: Jul. 20, 2023

(54) HARQ-ACK PROCESSING METHOD, APPARATUS, AND RELATED DEVICE

(71) Applicant: VIVO MOBILE COMMUNICATION CO., LTD., Dongguan (CN)

(72) Inventors: Xiaohang CHEN, Dongguan (CN); Xueming PAN, Dongguan (CN)

(73) Assignee: VIVO MOBILE COMMUNICATION CO., LTD., Dongguan (CN)

(21) Appl. No.: 18/125,683

(22) Filed: Mar. 23, 2023

Related U.S. Application Data
(63) Continuation of application No. PCT/CN2021/119850, filed on Sep. 23, 2021.

(30) Foreign Application Priority Data
Sep. 24, 2020 (CN) 202011019786.3

(51) Int. Cl. H04L 5/00; H04L 1/1812

(52) U.S. Cl. CPC H04L 5/0055; H04L 1/1812

(57) ABSTRACT

A Hybrid Automatic Repeat reQuest ACKnowledgment (HARQ-ACK) processing method, an apparatus, and a related device are provided. The method includes: receiving first indication information sent by a network device, where the first indication information is used to indicate a first operation; and in a case that a first Physical Uplink Control CHannel (PUCCH) overlaps a first uplink resource, performing the first operation. The first PUCCH carries a first HARQ-ACK. The first operation includes any one of the following: that the first HARQ-ACK is not multiplexed to the first uplink resource, that some HARQ-ACK in the first HARQ-ACKs is multiplexed to the first uplink resource, and that all HARQ-ACKs in the first HARQ-ACKs are multiplexed to the first uplink resource.

### CROSS-REFERENCE TO RELATED APPLICATIONS

This application is a continuation of International Application No. PCT/CN2021/119850, filed on Sep. 23, 2021, which claims priority to Chinese Patent Application No. 202011019786.3, filed on Sep. 24, 2020. The entire contents of each of the above-identified applications are expressly incorporated herein by reference.

### TECHNICAL FIELD

This application relates to the field of communications technologies, and in particular, to a HARQ-ACK processing method, an apparatus, and a related device.

### BACKGROUND

With development of communications technologies, communications systems are improving better. To improve transmission performance, a Hybrid Automatic Repeat request ACKnowledgement (HARQ-ACK) feedback mechanism is introduced. Generally, in a transmission process of a low priority HARQ-ACK, if the Physical Uplink Control CHannel (PUCCH) canying the HARQ-ACK overlaps the uplink resource carrying another piece of high priority information, the HARQ-ACK is directly discarded or multiplexed to the uplink resource. If the HARQ-ACK is discarded directly, downlink transmission performance corresponding to the HARQ-ACK is reduced. If the HARQ-ACK is multiplexed to the uplink resource, reliability of high priority information is reduced. Therefore, in the prior art, flexibility of HARQ-ACK transmission is poor, thereby affecting performance of the systems.

### SUMMARY

Embodiments of this application provide a HARQ-ACK processing method, an apparatus, and a related device.

According to a first aspect, a HARQ-ACK processing method is provided and performed by a network device, including:

receiving first indication information sent by a network device, where the first indication information is used to indicate a first operation; and

in a case that a first physical uplink control channel PUCCH overlaps a first uplink resource, performing the first operation.

The first PUCCH carries a first HARQ-ACK. The first operation includes any one of the following: that the first HARQ-ACK is not multiplexed to the first uplink resource, that some HARQ-ACK in the first HARQ-ACKs is multiplexed to the first uplink resource, and that all HARQ-ACKs in the first HARQ-ACKs are multiplexed to the first uplink resource.

According to a second aspect, a HARQ-ACK processing method is provided and performed by a network device, including:

sending first indication information, where the first indication information is used to indicate a first operation.

The first operation includes any one of the following: that a first HARQ-ACK is not multiplexed to a first uplink resource, that some HARQ-ACK in the first HARQ-ACKs is multiplexed to the first uplink resource, and that all HARQ-ACKs in the first HARQ-ACKs are multiplexed to the first uplink resource. The first uplink resource overlaps a first physical uplink control channel PUCCH, and the first PUCCH carries the first HARQ-ACK.

According to a third aspect, a HARQ-ACK processing apparatus is provided, including:

a receiving module, configured to receive a first indication information sent by a network device, where the first indication information is used to indicate a first operation; and

an execution module, configured to, in a case that a first physical uplink control channel PUCCH overlaps a first uplink resource, perform the first operation.

The first PUCCFI carries a first HARQ-ACK. The first operation includes any one of the following: that the first HARQ-ACK is not multiplexed to the first uplink resource, that some HARQ-ACK in the first HARQ-ACKs is multiplexed to the first uplink resource, and that all HARQ-ACKs in the first HARQ-ACKs are multiplexed to the first uplink resource.

According to a fourth aspect, a HARQ-ACK processing apparatus is provided, including:

a sending module, configured to send first indication information, where the first indication information is used to indicate a first operation.

The first operation includes any one of the following: that a first HARQ-ACK is not multiplexed to a first uplink resource, that some HARQ-ACK in the first HARQ-ACKs is multiplexed to the first uplink resource, and that all HARQ-ACKs in the first HARQ-ACKs are multiplexed to the first uplink resource. The first uplink resource overlaps a first physical uplink control channel PUCCH, and the first PUCCH carries the first HARQ-ACK.

According to a fifth aspect, a terminal is provided. The terminal includes a processor, a memory, and a program or an instruction stored in the memory and executable by the processor, where the program or the instruction, when executed by the processor, implements the steps of the method according to the first aspect.

According to a sixth aspect, a network device is provided. The network device includes a processor, a memory, and a program or an instruction stored in the memory and capable of running on the processor, where when the program or the instruction is executed by the processor, the steps of the method according to the second aspect are implemented.

According to a seventh aspect, a readable storage medium is provided. The readable storage medium stores a program or an instruction, and when the program or the instruction is executed by a processor, the steps of the method according to the first aspect are implemented, or the steps of the method according to the second aspect are implemented.

According to an eighth aspect, an embodiment of this application provides a chip. The chip includes a processor and a communications interface, the communications interface is coupled to the processor, and the processor is configured to run a program or an instruction of a network device, to implement the method according to the second aspect.

According to a ninth aspect, a computer software product is provided. The computer software product is stored in a non-volatile storage medium, and the software product is configured to be executed by at least one processor, to implement the steps of the method according to the first aspect, or the steps of the method according to the second aspect.

According to a tenth aspect, a communication device is provided, where the communication device is configured to perform the method described in the first aspect, or perform the method described in the second aspect.

In embodiments of this application, the network device sends the first indication information to indicate the first operation, and performs the first operation in a case that the first physical uplink control channel PUCCH overlaps the first uplink resource. The first PUCCH carries a first HARQ-ACK, and the first operation includes any one of the following: that the first HARQ-ACK is not multiplexed to the first uplink resource, that some HARQ-ACK in the first HARQ-ACKs is multiplexed to the first uplink resource, and that all HARQ-ACKs in the first HARQ-ACKs are multiplexed to the first uplink resource.

### BRIEF DESCRIPTION OF DRAWINGS

FIG. 1 is a structural diagram of a network system to which an embodiment of this application may he applied;

FIG. 2 is a flowchart of a HARQ-ACK processing method according to an embodiment of this application;

FIG. 3 is a first schematic transmission diagram of a HARQ-ACK processing method according to an embodiment of this application;

FIG. 4 is a second schematic transmission diagram of a HARQ-ACK processing method according to an embodiment of this application;

FIG. 5 is a third schematic transmission diagram of a HARQ-ACK processing method according to an embodiment of this application;

FIG. 6 is a fourth schematic transmission diagram of a HARQ-ACK processing method according to an embodiment of this application;

FIG. 7 is a fifth schematic transmission diagram of a HARQ-ACK processing method according to an embodiment of this application;

FIG. 8 is a sixth schematic transmission diagram of a HARQ-ACK processing method according to an embodiment of this application;

FIG. 9 is a flowchart of another HARQ-ACK processing method according to an embodiment of this application;

FIG. 10 is a structural diagram of a HARQ-ACK processing apparatus according to an embodiment of this application;

FIG. 11 is a structural diagram of another HARQ-ACK processing apparatus according to an embodiment of this application;

FIG. 12 is a structural diagram of a communications device according to an embodiment of this application;

FIG. 13 is a structural diagram of a terminal according to an embodiment of this application; and

FIG. 14 is a structural diagram of a network device according to an embodiment of this application.

### DETAILED DESCRIPTION

The following describes the embodiments of this application with reference to the accompanying drawings in the embodiments of this application. Apparently, the described embodiments are some but not all of the embodiments of this application. All other embodiments obtained by a person of ordinary skill in the art based on the embodiments of the present application shall fall within the protection scope of the present application.

The terms “first,” “second,” and the like in this specification and claims of the present application are used to distinguish between similar objects instead of describing a specific order or sequence. It should be understood that the terms used in this way is interchangeable in appropriate circumstances, so that the embodiments of this application can be implemented in other orders than the order illustrated or described herein. In addition, objects distinguished by “first” and “second” are usually of one category, and a quantity of objects is not limited. For example, a first object may mean one or more objects. In addition, “and/or” in the specification and claims represents at least one of connected objects. Symbol “/” in the specification generally represents an “or” relationship between associated objects.

It should be noted that the technologies described in the embodiments of this application are not limited to Long Term Evolution (LTE)/LTE-Advanced (LTE-A) systems, and may also be used in various wireless communications systems, such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. However, a New Radio (NR) system is described below as an example, and the term NR is used in most of the descriptions, although these technologies can also be used in an application other than an application of the NR system, for example, a 6th-Generation (6G) communications system.

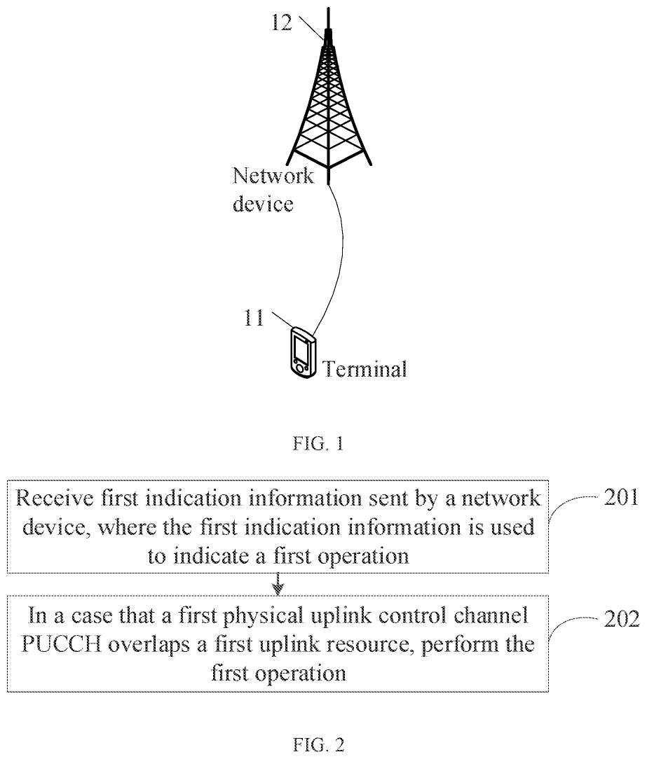

FIG. 1 is a block diagram of a wireless communications system to which embodiments of this application can be applied, The wireless communications system includes a terminal 11 and a network-side device 12. The terminal 11 may also be referred to as a terminal device or User Equipment (UE). The terminal 11 may be a terminal device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), a wearable device, Vehicle User Equipment (VUE), and. Pedestrian User Equipment (PUE). The wearable device includes a bracelet, a headset, and glasses. It should be noted that a specific type of the terminal 11 is not limited in the embodiments of this application. The network-side device 12 may be a base station or a core network. The base station may be referred to as a NodeB, an evolved NodeB, an access point, a Base Transceiver Station (BTS), a radio base station, a radio transceiver, a Basic Service Set (BSS), an Extended Service Set (ESS), a Node B, an evolved Node B (eNB), a home NodeB, a home evolved NodeB, a Wireless Local Area Network (WLAN) access point, a Wi-Fi node, a Transmitting Reception Point (TRP), or some other appropriate term in the art. It should be noted that the base station in the NR system is taken only as an example in the embodiments of this application, but a specific type of the base station is not limited.

For ease of understanding, the following describes some content involved in the embodiments of this application.

1. Unlicensed Band

In a future communications system, an unlicensed band may be used as a supplement to a licensed band to help an operator expand services. To be consistent with New Radio (NR) deployment and to maximize an NR-based unlicensed access, the unlicensed band can work in hands of 5 GHz, 37 GHz, and 60 GHz. A large bandwidth (80 or 100 MHz) of the unlicensed band can reduce implementation complexity of a base station and UE. Because the unlicensed hand is shared by various Radio Access Technology (RAT), such as Wireless Fidelity (WiFi), a radar, and a LTE-License Assisted Access (LAA), in some countries or regions, use of the unlicensed band must comply with regulations, such as Listen Before Talk (LBT), Maximum Channel Occupancy Time (MCOT), and other regulations, to ensure that all devices can use such resource fairly. When a transmission node needs to send information and needs to perform LBT first, Energy Detection (ED) is performed on surrounding nodes. When detected energy is lower than a threshold, a channel is considered to be idle, and the transmission node can perform sending. Otherwise, the channel is considered to be busy, and the transmission node cannot perform sending. The transmission node may be a base station, UE, a WiFi Access Point (AP), and the like. After the transmission node starts transmitting, Channel Occupancy Time (COT) cannot exceed MCOT.

2. LBT

Common LBT categories can be divided into category 1, category 2, and category 4. Category 1 LBT means that a sending node does not perform LBT, that is, no LBT, or means that immediate transmission Category 2 LBT is one-shot LBT, that is, a node performs LBT once before transmission. If the channel is idle, the transmission is performed. If the channel is busy, the transmission is not performed. Category 4 LBT is a channel listening mechanism based on back-off. When a transmission node detects that the channel is busy, back-off is performed and listening is performed until it is detected that the channel is idle.

For the base station, Category 2 LBT is applied to a Physical Downlink Shared CHannel (PDSCH) except a Downlink UE-specific Reference Signal (DRS), that is, a DRS without the PDSCH. Category 4 LBT is applied for a PDSCH, Downlink Control Information (DCI) or enhanced Downlink Control Information (eDCI). For UE, category 4 LBT corresponds to a type 1 UL channel access procedure, and category 2 LBT corresponds to a type 2 UL channel access procedure. In addition, a new category 2 LBT is added in the unlicensed band of NR (NR-U), which corresponds to a gap of 16 us.

3. HARQ-ACK Timing

HARQ-ACK timing is defined as a gap between time of finishing receiving Downlink (DL) data and time of a feedback corresponding to positive acknowledgement ACKnowledgement (ACK) or Negative. ACKnowledgement (NACK). NR supports flexible HARQ-ACK timing configuration to adapt to different services and network deployments. Each UE can configure a dedicated HARQ-ACK timing table for the UE through Radio Resource Control (RRC). This table contains a plurality of HARQ-ACK timing values becoming K1 values. K1 uses a slot as a unit, When the base station dynamically schedules downlink data transmission, the base station indicates a K1 value in the DCI in the form of an index. This K 1 is a value selected from the dedicated HARQ-ACK timing table of the UE, and is used to notify the UE of the time when the UE feeds back the HARQ-ACK.

If the DCI does not contain a field indicating HARQ-ACK timing, the UE can determine the gap between downlink data and. HARQ-ACK feedback based on a fixed value.

For a downlink Semi-Persistent Scheduling (SPS) PDSCH sent in slot n, its corresponding HARQ-ACK is transmitted in slot n+K, where K is indicated in the DCI that activates the downlink SPS.

4. HARQ-ACK Codebook

For a HARQ-ACK process that supports TB level feedback, each Transport Block (TB) corresponds to a feedback HARQ-ACK bit, supports a plurality of downlink HARQ processes for each UE, and also supports a single DL HARQ process for each UE. The UE needs to indicate its capacity for minimum HARQ processing time (minimum HARQ processing time means minimum time required to receive the corresponding HARQ-ACK transmission timing from downlink data). Enhanced Mobile BroadBand (eMBB) and Ultra-Reliable and Low Latency Communication (URLLC) support asynchronous and adaptive Downlink HARQ. From a perspective of UE, a HARQ-ACK feedback of a plurality of PDSCHs can be transmitted in an UpLink (UL) data or a control area in time, forming a HARQ-ACK codebook on this UL. Timing between PDSCH reception and corresponding ACK/NACK is specified in the DCI.

In some implementations, a HARQ-ACK codebook includes two types. Type-1 is a semi static HARQ-ACK codebook and type-2 is a dynamic HARQ-ACK codebook. For semi static HARQ-ACK codebook, the UE determines all PDSCHs that may be fed back in a slot and the HARQ-ACK codebook based on monitoring occasion of a Physical Downlink Control CHannel (PDSCH) configured by the RRC, PDSCH-Time Domain Resource Allocation (PDSCH-Time Domain Resource Allocation), PDSCH-to-HARQ-ACK feedback timing (DL-Data To UL-ACK or PDSCH-to-HARQ timing) and other parameters. Because a HARQ for an actually scheduled PDSCH and PDSCH for scheduling might be included, the codebook is generally large. For the dynamic HARQ-ACK codebook, the UE determines the HARQ-ACK codebook based on the actually scheduled PDSCH. Because only the actually scheduled PDSCH is fed back, a size of the HARQ-ACK codebook is usually smaller than a size of the semi-static HARQ-ACK codebook. A specific type of codebook used by the LTE is determined by RRC configuration.

5. Method of Determining a Physical Uplink Control CHannel (PUCCH) Resource

The base station can configure one or more (up to four) PUCCH resource sets for each UE through RRC signaling. The RRC configures or predefines a maximum quantity of bits of an Uplink Control Information (UCI) payload that each REsource SET (RESET)can carry. Each RESET can contain a plurality of PUCCH resources (the first RESET can contain up to 32 PUCCH resources, and each of other RESETS can contain up to 8 PUCCH resources). On a UE side, the UE needs to teed back the HARQ-ACK after receiving the PDSCH. To determine the PUCCH resource where the HARQ-ACK is fed back, the UE needs to first determine the slot where the PUCCH is located by scheduling K1 in the PDCCH of the PDSCH, and then determine the RESET where the PUCCH is located through the bit quantity of the to-be-fed back HARQ-ACK, and in the determined RESET, determine the PUCCH resource in the RESET (when the RESET contains more than 8 resources) based on a PUCCH Resource Indicator (PRI) field (when the RESET contains no more than 8 resources) or an index of a first Control Channel Element (CCE) of the PRI plus the PDCCH (first CCE index), When a HARQ-ACK of a plurality of PDSCHs is fed back in one slot, the UE determines the PUCCH resource based on the PRI and CCE index in the last DCI of these PDSCHs.

The following describes in detail the HARQ-ACK processing method provided in the embodiments of this application through some embodiments and application scenarios thereof with reference to the accompanying drawings.

Referring to FIG. 2, FIG. 2 is a flowchart of a HARQ-ACK processing method according to an embodiment of this application. The method is performed by a terminal. As shown in FIG. 2, the method includes the following steps.

Step 201: Receive first indication information sent by a network device, where the first indication information is used to indicate a first operation.

Step 202: In a case that a first Physical Uplink Control CHannel (PUCCH) overlaps a first uplink resource, perform the first operation.

The first PUCCH carries a first HARQ-ACK. The first operation includes any one of the following: that the first HARQ-ACK is not multiplexed to the first uplink resource, that some HARQ-ACK in the first HARQ-ACK is multiplexed to the first uplink resource, and that all HARQ-ACKs in the first HARQ-ACKs are multiplexed to the first uplink resource.

In this embodiment of this application, the first HARQ-ACK is a HARQ-ACK corresponding to a semi-persistent scheduling Physical Downlink Shared CHannel (PDSCH), or a HARQ-ACK corresponding to a downlink grant scheduling PDSCH. The first uplink resource may include a second PUCCH or a first Physical Uplink Shared CHannel (PUSCH).

It should be understood that the above first indication information can be carried on DCI or RRC signaling that are sent by a network.

In some implementations, when the first indication information is carried in DCI, the DCI may be DCI that schedules the first PUCCH or the first uplink resource, for example, uplink grant of the first uplink resource or downlink grant corresponding to the first PUCCH.

In some implementations, the RRC signaling may indicate one or more operations: that the first HARQ-ACK is not multiplexed to the first uplink resource, that some HARQ-ACK in the first HARQ-ACK is multiplexed to the first uplink resource, and that all HARQ-ACKs in the first HARQ-ACKs are multiplexed to the first uplink resource. The first indication information is indicated through the DCI to determine which one is used.

In some implementations, the first uplink resource is a semi-static transmitting uplink resource. For example, the first PUSCH may be a semi-static transmitting PUSCH. The second PUCCH may be a semi-static transmitting PUCCH. The second PUCCH is used to transmit the HARQ-ACK corresponding to the SPS PDSCH. In other embodiments, the first PUSCH may also be the PUSCH for uplink grant scheduling, and the second PUCCH may also be the PUCCH corresponding to the PDSCH for uplink grant scheduling, and is used to transmit the HARQ-ACK of the PDSCH for uplink grant scheduling.

It should be understood that in this embodiment of this application, the network device can decide and indicate the first operation according to an actual situation, so that a transmission state of the first HARQ-ACK can be flexibly controlled. For example, in some cases, when it is necessary to ensure reliability of the transmission of the first uplink resource, it can be indicated that the first HARQ-ACK is not multiplexed to the first uplink resource. In some cases, it is necessary to ensure performance of the downlink transmission corresponding to the first HARQ-ACK, it can be indicated that all HARQ-ACKs of the first HARQ-ACKs are multiplexed to the first uplink resource. In some cases, if both the reliability of the first uplink resource transmission and the performance of the downlink transmission corresponding to the first HARQ-ACK are achieved, it can be indicated that some HARQ-ACK of the first HARQ-ACK is multiplexed to the first uplink resource.

It should be noted that in this embodiment of this application, the first operation indicated by the first indication information can take effect only in a case the first PUCCH overlaps the first uplink resource; or the first operation can also take effect in a case that the first PUCCH does not overlap the first uplink resource. In the following embodiments, the first operation takes effect only in a case that the first PUCCH overlaps the first uplink resource. To be specific, the first HARQ-ACK on the first PUCCH is executed based on the first operation only in a case that the first PUCCH overlaps the first uplink resource. The first PUCCH overlapping the first uplink resource can be understood as a conflict between the first PUCCH and the first uplink resource. In some implementations, the first PUCCH can overlap some resources of the first uplink resources, or all resources of the first uplink resources.

In this embodiment of this application, the network device sends the first indication information to indicate the first operation, and performs the first operation in a case that the first PUCCH overlaps the first uplink resource. The first PUCCH carries a first HARQ-ACK, and the first operation includes any one of the following: that the first HARQ-ACK is not multiplexed to the first uplink resource, that some HARQ-ACK in the first HARQ-ACKs is multiplexed to the first uplink resource, and that all HARQ-ACKs in the first HARQ-ACKs are multiplexed to the first uplink resource. In this way, the network device can flexibly control a multiplexing state of the first HARQ-ACK, thereby improving flexibility of HARQ-ACK transmission and performance of the system.

In this embodiment of this application, a priority of the first HARQ-ACK may be lower than a priority of the first uplink resource.

The foregoing priority can be understood as a transmission priority, which can be agreed by a protocol or configured or indicated by a network device The priority of the first HARQ-ACK may be a priority of a HARQ-ACK codebook corresponding to the first HARQ-ACK, a priority of a :PDSCH corresponding to the first HARQ-ACK, or a priority indicated by DCI corresponding to the first HARQ-ACK. The priority of the first uplink resource may be a priority of the uplink control information or uplink data carried by the first uplink resource, a priority of a physical channel corresponding to the first uplink resource, or a priority indicated by DCI corresponding to the first uplink resource.

It should be understood that the terminal can confirm whether to multiplex the first HARQ-ACK to the first uplink resource after receiving the foregoing first indication information. For different operations indicated by the indication information, the corresponding terminal behaviors are different.

In an embodiment, in a case that the first operation includes that all HARQ-ACKs in the first HARQ-ACKs are multiplexed to the first uplink resource, the method further includes:

compressing the first HARQ-ACK by using a preset compression method.

The preset compression method includes at least one of the following: a time domain compression method, a frequency domain compression method, and a spatial domain compression method.

In this embodiment of this application, compression may be understood as bundle. In a case that the first operation indicated by the first indication information is that all HARQ-ACKs in the first HARQ-ACK are multiplexed to the first uplink resource, a first HAR.Q-ACK of L1 bit can be bundled to a HARQ-ACK of L2 bit, where L2 is an integer smaller than L1. The first HARQ-ACK is compressed and then multiplexed to the first uplink resource for transmission, which can reduce the resources occupied by the multiplexing and improve reliability of the first uplink resource transmission. In some implementations, the compression method of the first HARQ-ACK may be configured according to an actual need, and is not further limited herein. In some embodiments, the first HARQ-ACK can also be directly multiplexed to the first uplink resource for transmission without being compressed. In an embodiment, in a case that the first operation includes that some HARQ-ACK in the first HARQ-ACKs is multiplexed to the first uplink resource, the some HARQ-ACK corresponds to a target object, where the target object includes at least one of the following:

a PDSCH in at least one PDSCH group;

PDSCHs of M HARQ processes, where the M is a positive integer; and

at least one PDSCH before the first indication information is received.

Some HARQ-ACK corresponding to a PDSCH in at least one PDSCH group can be understood as some HARQ-ACK corresponding to at least one PDSCH group. In some implementations, assuming that the PDSCHs are divided in groups, a HARQ-ACK corresponding to all PDSCHs in one or more PDSCH groups can be multiplexed. For example, if N PDSCH groups are included, the foregoing HARQ-ACK can correspond to M PDSCH packets, and M is a positive integer smaller than N.

Some HARQ-ACK corresponds to a PDSCH of M HARQ processes. In this case, at least one of a value of the M, and process numbers of the M processes can be configured by a network device. For example, the network device can configure one of the value of the M, and the process numbers of the M processes for a terminal through RRC signaling.

That some HARQ-ACK corresponds to at least one PDSCH before the first indication information can be understood as that a HARQ-ACK of a PDSCH after the first indication information is received cannot be multiplexed to the first uplink resource. In some implementations, the foregoing first indication information can be carried in a UL grant message, that is, a low priority HARQ-ACK of the PDSCH after the UL grant is received cannot be multiplexed to a high priority first PUSCH or a high priority second PUCCH.

It should be noted that the at least one PDSCH before the first indication information is received can be understood as that a time point of receiving the first indication information is after a start position or an end position of the at least one PDSCH. In other words, the start position or the end position of the at least one PDSCH is located before the time point of receiving the first indication information.

In some implementations, in a case that the first operation is that the first HARQ-ACK is not multiplexed to the first uplink resource or that some HARQ-ACK in the first HARQ-ACKs is multiplexed to the first uplink resource, the method further includes:

discarding or delaying sending a target HARQ-ACK, where the target HARQ-ACK is a HARQ-ACK in the first HARQ-ACK that is not multiplexed to the first uplink resource.

In this embodiment of this application, operation behaviors of the target HARQ-ACK can be indicated by a protocol agreement or a network device. When it is indicated by the network device, before a step of discarding or delaying sending a target HARQ-ACK, the method further includes:

receiving second indication information sent by the network device, where the second indication information is used to indicate discarding or delaying sending the target HARQ-ACK.

In some implementations, when the network device indicates discarding the target HARQ-ACK through the second indication information, the terminal can directly discard the target HARQ-ACK. When the network device indicates delaying the target HARQ-ACK, the transmission of the target HARQ-ACK can be delayed.

In this embodiment of this application, the foregoing second indication information can be carried in the uplink grant of the first uplink resource or the downlink grant corresponding to the first PUCCH (for example, DL grant for LP-PUCCH), or can also be carried in the RRC configuration. This is not further limited herein. It should be understood that the uplink grant or downlink grant can be DCI of scheduling data or not scheduling data.

In some implementations, the delaying sending the target HARQ-ACK includes:

sending the target HARQ-ACK on a second uplink resource, where the second uplink resource is located behind a first object, and the first object includes at least one of the first PUCCH and the first uplink resource.

In this embodiment of this application, the above target HARQ-ACK can be transmitted on the uplink resource behind the first object. In some implementations, the second uplink resource includes a PUCCH or a PUSCH. In some implementations, the transmission of the target HARQ-ACK can be delayed on the PUCCH, or the transmission of the target HARQ-ACK can be delayed on the PUSCH.

In some implementations, the second uplink resource is indicated based on a protocol agreement or a network device. The second uplink resource may be an uplink resource that meets a certain condition.

In some embodiments, the second uplink resource is a PUCCH or a PUSCH nearest to the first object.

In some embodiments, the second uplink resource is a dynamic scheduling or semi-static configuration uplink resource. For example, in a case that the second uplink resource is a PUCCH, the second uplink resource can carry Period Channel State Information (P-CSI), Semi-Persistent Channel State Information (SP-CSI), or a Scheduling Request (SR). In a case that the second uplink resource is a PUSCH, the second uplink resource may also be a MSC:II that carries aperiodic CSI or semi-static CSI.

In some embodiments, in a case that the second uplink resource is a PUCCH, the second uplink resource may also meet the following condition:

that the second uplink resource can carry at least one HARQ-ACK codebook, where the at least one HARQ-ACK codebook is Type 3 HARQ-ACK codebook or Enhanced Type 2 HARQ-ACK codebook.

It should be understood that the second uplink resource can be indicated by DCI or RRC signaling. The DCI may be DCI that schedules the first uplink resource or other pieces of DCI, for example, used to schedule indication of UL grant for HP-PUSCH, or perform indication through DL grant for LP-PUCCH, The DL grant for LP-PUCCH can be understood as that the PUCCH where the HARQ-ACK corresponding to the PUSCH for downlink grant scheduling is located is a low priority PUCCH.

To better understand this application, the specific implementation of this application is described in detail below through specific embodiments.

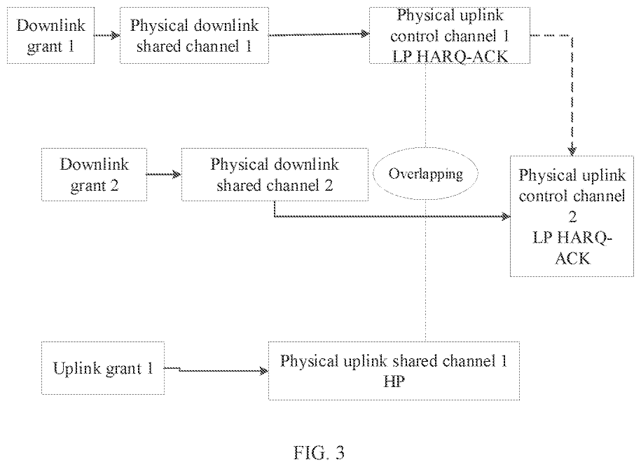

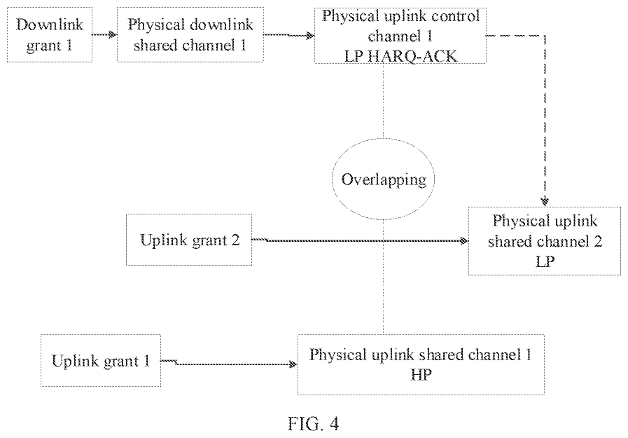

Solution 1: As shown in FIG. 3 and FIG. 4, the PUCCH used to transmit the Low Priority (LP) HARQ-ACK overlaps a High Priority (HP) PUSCH 1.

The LP HARQ-ACK is transmitted on the PUCCH 1. The PUCCH 1 conflicts with the HP PUSCH 1.

In some implementations, the LP HARQ-ACK is a HARQ-ACK corresponding to SPS PDSCH, or the LP HARQ-ACK is a HARQ-ACK corresponding to a PDSCH scheduled by DL grant 1.

In some implementations, the HP PUSCH is a semi-static transmitting PUSCH, such as a configured grant PUSCH, or a PUSCH scheduled by UL grant.

In solution 1, whether the LP HARQ-ACK is multiplexed to the HP PUSCH based on indication information of the LT grant. In some implementations, the LT grant can indicate one of the following:

Operation 1: Do not allow the LP HARQ-ACK to be multiplexed to the HP PUSCH;

Operation 2: Allow all the LP HARQ-ACKs to be multiplexed to the HP PUSCH; and

Operation 3: Allow some LP HARQ-ACK to be multiplexed to the HP PUSCH.

For Operation 2, the LP HARQ-ACK can be bundled to be X bit (s), where the X is a positive integer. For example, spatial domain bundle, time domain bundle, or frequency domain bundle can be performed.

For Operation 3, some LP HARQ-ACK can meet at least one of the following:

that if PDSCHs are divided into groups (N groups, and N>1), the some LP HARQ-ACK corresponds to M PDSCH groups, and M is a positive integer smaller than N;

that the some LP HARQ-ACK corresponds to a PDSCH of M HARQ processes, where the M is a positive integer smaller than N, N is a maximum quantity of the HARQ processes, and a value of the M and/or a process number of the M HARQ processes can be configured by RRC; and

that the some LP HARQ-ACK, is a LP HARQ-ACK of a PDSCH before the UL grant is received, that is, the LP HARQ-ACK of the PDSCH after the UL grant is received cannot be multiplexed on the HP PUSCH.

For the foregoing Operation 1 and Operation 3, a processing method of the LP HARQ-ACK includes:

Method 1: Discard the arget LP HARQ-ACK that cannot be multiplexed to the HP PUSCH; and

Method 2: Delay transmission of the target LP HARQ-ACK that cannot be multiplexed to the HP PUSCH.

In some implementations, for Method 2, the transmission of the target LP HARQ-ACK can be delayed by indicating a Non-Numerical K1 (NNK1) in the DCI that schedules the LP HARQ-ACK or the HP PUSCH, For example, the target LP HARQ-ACK can be delayed and transmitted on a subsequent uplink resource.

As shown in FIG. 3, in an embodiment, the target LP HARQ-ACK is transmitted on a PUCCH 2.

In some implementations, in an embodiment, the PUCCH 2 may be a PUCCH.

In some implementations, the PUCCH 2 is the nearest PUCCH after the HP PUSCH.

In some implementations, the target LP HARQ-ACK is multiplexed to the PUCCH 2.

In some implementations, the PUCCH 2 carries at least one HARQ-ACK codebook. The at least one HARQ-ACK codebook is a Type 3 HARQ-ACK codebook or an Enhanced Type 2 HARQ-ACK codebook.

In some implementations, the PUCCH 2 can carry P-CSI, SP-CSI, or a SR.

In some implementations, the PUCCH 2 may be indicated by DL grant 2 or a RRC configuration.

As shown in FIG. 4, in an embodiment, the PUCCH 2 may be a PUSCH 2, for example, the PUSCH 2 is the nearest PUSCH after the HP PUSCH.

In some implementations, the PUSCH 2 is a PUSCH scheduled by the UL grant 2 or a semi-static configured PUSCH.

In some implementations, the PUSCH can carry a PUSCH of aperiodic CSI or semi-static CSI.

It should be noted that the foregoing processing method of the LP HARQ-ACK can be indicated through the uplink grant used to schedule the HP PUSCH, or indicated through downlink grant corresponding to the LP PUCCH, or configured through the RRC configuration. The uplink grant or downlink grant may be DCI that schedules data or does not schedule data.

Embodiment 1: Based on indication information of the UL grant 1, all or some of the LP HARQ-ACKs 1 cannot be multiplexed to the HP PUSCH.

A PDSCH 2 scheduled by the DL grant 2 and the corresponding HARQ-ACK 2 are transmitted on the PUCCH 2. The DL grant 2 is before the UL grant 1, and the PUCCH 2 is after the PUSCH 1. The PUCCH 2 does not conflict with the PUSCH 1.

Based on indication of DCI (UL grant or DL grant), all or some of the LP HARQ-ACKs 1 can be multiplexed with the HARQ-ACK 2 on the PUCCH 2 for transmission.

Method 1: The HARQ-ACK I and the HARQ-ACK 2 are divided into groups, and a serial number is indicated by corresponding DCI (DL grant 1 and DL grant 2).

The HARQ-ACK 1 and the HARQ-ACK 2 can be divided into groups based on the corresponding HARQ-ACK codebook (for example, different HARQ-ACK codebooks belong to different groups), or based on group information indicated by the DCI.

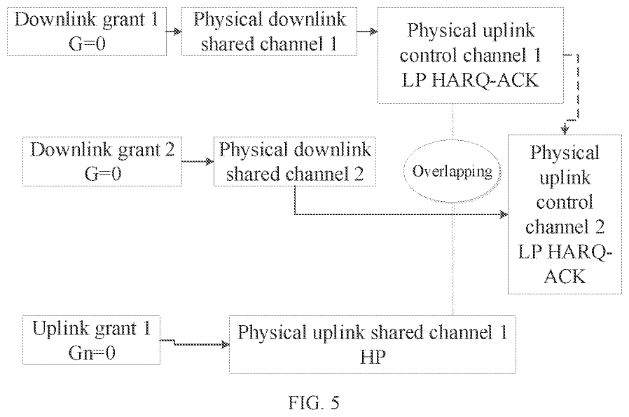

Method 1-1: DCI (UL grant 1 or DL grant 2) indicates first information, where the first information indicates a first serial number (represented by G in the figures), and when a serial number of the HARQ-ACK 1 is the same as the first serial number, UE can multiplex the HARQ-ACK 1 on the PUCCH 2 for transmission, as shown in FIG. 5.

Method 1-2: DCI (DL grant 2) indicates second information, where the second information indicates a first quantity (represented by Gn in the figure), and the first quantity indicates a quantity of HARQ-ACK groups that the PUCCH 2 can transmit.

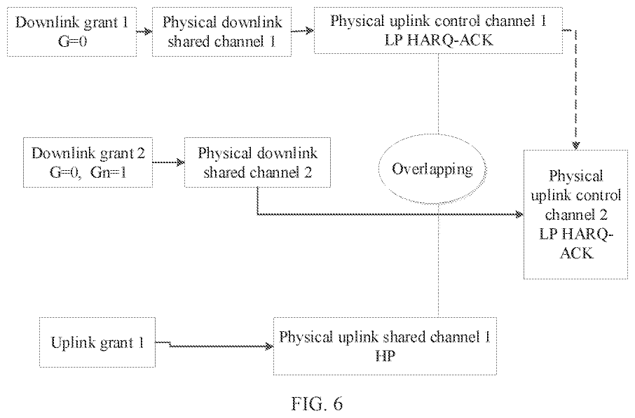

In some implementations, when the first quantity is indicated to be 1, and when a serial number of HARQ-ACK 1 is the same as a serial number of the HARQ-ACK 2, the UE can multiplex the HARQ-ACK 1 on the PUCCH 2 for transmission, as shown in FIG. 6.

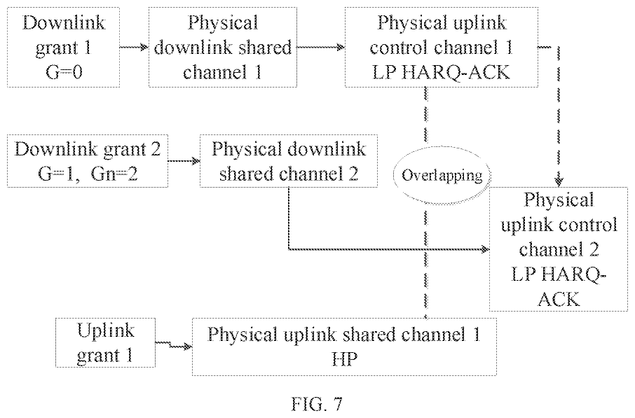

In some implementations, when the first quantity is indicated to be greater than 1, the UE can multiplex the HARQ-ACK 1 on the PUCCH 2 for transmission, as shown in FIG. 7. In other words, no matter whether the quantity of the HARQ-ACK 1 is the same as the quantity of the HARQ-ACK 2, the UE can multiplex the HARQ-ACK 1 and the HARQ-ACK 2 on the PUCCH 2 for transmission.

In some implementations, in a case that a priority of the HARQ-ACK 2 carried by the PUCCH 2 is higher than a priority of the HARQ-ACK 1. In this case, in an embodiment, the UE may not multiplex the HARQ-ACK 1 to the PUCCH 2 for transmission. In another embodiment, the UE can multiplex and encode independently the HARQ-ACK 1 and the HARQ-ACK 2 to the PUCCH 2 for transmission.

Method 1-3: RRC configures a list containing one or more states, and each state indicates whether the LP HARQ-ACK allows multiplexing, where DCI (UL grant 1 or DL grant 2) indicates an entry in a list configured by the RRC to determine whether to multiplex.

Each state can correspond to any one of the following:

not allowing multiplexing; and

allowing multiplexing of a LP HARQ-ACK with a serial number X and a HARQ-ACK with a serial number Y, where X=Y or X is not equal to Y.

The RRC configures a list. The list may include one or more items in Table 1 below.

TABLE 1

| State | Corresponding behavior |
|---|---|
| 0 | A LP HARQ-ACK is not allowed to be multiplexed with another HARQ-ACK |
| 1 | A LP HARQ-ACK with a serial number = 0 is allowed to be multiplexed with a |
| | HARQ-ACK with a serial number = 0 |
| 2 | A LP HARQ-ACK with a serial number = 1 is allowed to be multiplexed with a |
| | HARQ-ACK with a serial number = 1 |
| 3 | A LP HARQ-ACK with a serial number = 0 is allowed to be multiplexed with a |
| | HARQ-ACK with a serial number = 1 |
| 4 | A LP HARQ-ACK with a serial number = 1 is allowed to be multiplexed with a |
| | HARQ-ACK with a serial number = 0 |
| 5 | A LP HARQ-ACK with a serial number = 0 or 1 is allowed to be multiplexed |
| | with a HARQ-ACK with a serial number = 0 |
| 6 | A LP HARQ-ACK with a serial number = 0 or 1 is allowed to be multiplexed |
| | with a HARQ-ACK with a serial number = 1 |
| 7 | A LP HARQ-ACK with a serial number = 0 is allowed to be multiplexed with a |
| | HARQ-ACK with a serial number = 0 or 1 |
| 8 | A LP HARQ-ACK with a serial number = 1 is allowed to be multiplexed with a |
| | HARQ-ACK with a serial number = 0 or 1 |
| . . . | . . . |

Embodiment 2: Time relationship between receiving time of DL grant/UL grant and sending time of a PUCCH.

When DL grant 2 indicates that a HARQ-ACK 1 is allowed to be multiplexed with a HARQ-ACK 2 on a PUCCH 2 for transmission, the following conditions shall be met:

that receiving time of the DL grant 2 is X slots/symbols before a PUCCH 1, where

for example, start time of the DL grant 2 is X1 slots/symbols before starting time of the PUCCH 1, or end time of the DL grant 2 is X2 slots/symbols before start time of the PUCCH 1; and

that the receiving time of the DL grant 2 is Y slots/symbols after UL grant 1, where

for example, the start time of DL grant 2 is Y1 slots/symbols after start time of grant 1, or the starting time of DL grant 2 is Y2 slots/symbols after end time of UL grant 1, or the end time of DL grant 2 is Y3 slots/symbols after the end time of UL grant 1.

When UL grant indicates that the HARQ-ACK 1 is allowed to be multiplexed with the HARQ-ACK 2 on the PUCCH 2. for transmission, at least following conditions should be met:

that receiving time of the UL grant is located at the DL grant 2, that is, X slots/symbols after the DCI that schedules the HARQ-ACK 2; or the receiving time of the UL grant is located at the PUCCH 2, that is, Y slots/symbols before the PUCCH that carries the HARQ-ACK 2; where

for example, start time of the UL grant is X1 slots/symbols after start time of the DL grant 2, the start time of the UL grant is X2 slots/symbols after end time of the DL grant 2, end time of the UL grant is X3 slots/symbols after the end time of the DL grant 2. the start time of the UL grant is Y1 slots/symbols before start time of the PUCCH 2, or the end time of the UL grant is Y2 slots/symbols before the start time of PUCCH 2; and

that sending time of the PUCCH 2 is Z slots/symbols after the PUCCH 1, where

for example, the start time of the PUCCH 2 is Z slots/symbols after end time of the PUCCH 1,

When the UL grant 2 indicates that the HARQ-ACK 1 is allowed to be multiplexed on PUCCH 2 for transmission, the following conditions shall be met:

that receiving time of the UL grant 2 is X slots/symbols before the PUCCH 1, where

for example, the start time of the UL grant 2 is X1 slots/symbols before start time of the PUCCH 1, or the end time of the UL grant 2 is X2 slots/symbols before the start time of PUCCH 1;

sending time of the PUSCH 2 is Y slots/symbols after the PUCCH 1, where

for example, the start time of the PUSCH 2 is Y1 slots/symbols after the end time of the PUCCH 1; and

that receiving time of the UL grant 2 is Z slots/symbols before a PUSCH 1, where

for example, starting time of the UL grant 2 is Z1 sluts/symbols before start time of the PUSCH 1, or the end time of the UL grant 2 is Z2 slots/symbols before the start time of the PUSCH 1.

Solution 2: As shown in FIG. 8, a. PUCCH used to transmit a low priority HARQ-ACK overlaps a high priority PUSCH.

The LP HARQ-ACK is transmitted on the PUCCH 1. The PUCCH 1 conflicts with the HP PUSCH 1.

In some implementations, the LP HARQ-ACK is a HARQ-ACK corresponding to a SPS PDSCH, or the LP HARQ-ACK is a HARQ-ACK corresponding to a PDSCH scheduled by the DL grant 1.

In some implementations, the HP PUCCH 2 is a semi-static transmitting PUCCH, such as a HARQ-ACK corresponding to a SPS PDSCH, or a PUCCH corresponding to a PDSCH scheduled by the DL grant 2.

In Solution 2.: It can be determined whether the LP HARQ-ACK is multiplexed to the HP PUCCH based on indication information of the DL grant 2. In some implementations, DL grant for HP PUCCH can indicate one of the following:

Operation 4: A LP HARQ-ACK is not allowed to be multiplexed to a HP PUCCH;

Operation 5: All LP HARQ-ACKs are allowed to be multiplexed to the HP PUCCH; and

Operation 6: Some LP HARQ-ACK is allowed to be multiplexed to the HP PUCCH.

For Operation 5, the LP HARQ-ACK can be bundled to be X bit(s), where the X is a positive integer. For example, spatial domain bundle, time domain bundle, or frequency domain bundle can be performed.

For Operation 6, some LP HARQ-ACK can be multiplexed on the HP PUCCH.

The some LP HARQ-ACK may meet at least one of the following conditions:

that if PDSCHs are divided into groups (N groups, and N>1), the some LP HARQ-ACK corresponds to NI PDSCH groups, and M is a positive integer smaller than N;

that the some LP HARQ-ACK corresponds to a PDSCH of M HARQ processes, where the M is a positive integer smaller than N, N is a maximum quantity of the HARQ processes, and a value of the M and/or a process number of the M HARQ processes can be configured by RRC; and

that the some LP HARQ-ACK is a LP HARQ-ACK: of a PDSCH before DL grant 2 is received, that is, the LP HARQ-ACK of the PDSCH after the DL grant 2 is received cannot be multiplexed on the HP PUCCH 2.

For Operation 4 and Operation 6, the processing method of the LP HARQ-ACK is the same as Operation 1 and Operation 3. In some implementations, refer to the foregoing description of Solution 1. Details are not described herein.

Embodiment 3: A PDSCH 2 scheduled by the DL grant 2 and the corresponding

I TP HARQ-ACK are transmitted on the PUCCH 2. The DL grant 2 is located before the UL grant 1, and the PUCCH 2 is located after the PUSCH 1. The PUCCH 2 does not conflict with the PUSCH 1.

Based on indication of DCI (UL grant 1 or DL grant 2), all or some of the LP HARQ-ACKs 1 can be multiplexed on the PUSCH 1 for transmission.

Method 2: The HARQ-ACK. I and/or the HARQ-ACK. 2 are divided into groups, and a serial number is indicated by corresponding DCI (DL grant 1 and. DL grant 2). The HARQ-ACK 2 is a HARQ-ACK corresponding to a PDSCH 2 scheduled by the DL grant 2, and can also be called a HP HARQ-ACK 2 or a HP HARQ-ACK.

In some implementations, the HARQ-ACK 1 and the HARQ-ACK 2 can be divided into groups based on the corresponding HARQ-ACK codebook (for example, different HARQ-ACK codebooks belong to different groups), or based on group information indicated by the DCI.

Method 2-1: DCI (UL grant 1) indicates first information, where the first information indicates a first serial number, and when a serial number of the HARQ-ACK 1 is the same as the first serial number, UE can multiplex the HARQ-ACK 1 on the PUSCH 1 for transmission.

Method 2-2: DCI (UL grant 2) indicates second information, where the second information indicates a first quantity, and the first quantity indicates a quantity of HARQ-ACK groups that the PUCCH 2 can transmit.

In some implementations, when the first quantity is indicated to be 1, when the PUSCH 1 contains only one HARQ-ACK group, UE can multiplex the HARQ-ACK 1 on the PUSCH 1 for transmission,

In some implementations, when the first quantity is indicated to be greater than 1, the UE can multiplex the HARQ-ACK 1 on the PUSCH 1 for transmission. In other words, no matter whether the quantity of the HARQ-ACK 1 is the same as the quantity of the HARQ-ACK 2, the UE can multiplex the HARQ-ACK 1 and the HARQ-ACK 2 on the PUCCH 2 for transmission.

In some implementations, if a priority of the PUSCH 2 is higher than that of the HARQ-ACK 1. In this case, in an embodiment, the UE may not multiplex the HARQ-ACK 1 to the PUCCH 2 for transmission. In another embodiment, the UE can multiplex and encode independently the HARQ-ACK 1 to the PUSCH 1 for transmission,

Method 2-3: RRC configures a list containing one or more states, and each state indicates whether the LP HARQ-ACK allows multiplexing, where DCI (UL grant 1 or DL grant 2) indicates an entry in a list configured by the RRC to determine whether to multiplex.

Each state can correspond to any one of the following:

not allowing multiplexing; and

allowing multiplexing of a LP HARQ-ACK with a serial number X and a HARQ-ACK with a serial number Y, where X=Y or X is not equal to Y.

The RRC configures a list. The list may include one or more items in Table 2 below.

TABLE 2

| State | Corresponding behavior |
|---|---|
| 0 | A LP HARQ-ACK is not allowed to be multiplexed to a PUSCH |
| 1 | A LPHARQ-ACK with a serial number = 0 is allowed to be multiplexed to a |
| | PUSCH, and a corresponding serial number of the PUSCH (DCI indication |
| | or RRC configuration) = 0 |
| 2 | A LPHARQ-ACK with a serial number = 1 is allowed to be multiplexed to a |
| | PUSCH, and a corresponding serial number of the PUSCH (DCI indication |
| | or RRC configuration) = 1 |
| 3 | A LPHARQ-ACK with a serial number = 0 is allowed to be multiplexed to a |
| | PUSCH, and a corresponding serial number of the PUSCH (DCI indication |
| | or RRC configuration) = 1 |
| 4 | A LPHARQ-ACK with a serial number = 1 is allowed to be multiplexed to a |
| | PUSCH, and a corresponding serial number of the PUSCH (DCI indication |
| | or RRC configuration) = 0 |
| 5 | A LP HARQ-ACK with a serial number = 0 is allowed to be multiplexed to a |
| | PUSCH |
| 6 | A LP HARQ-ACK with a serial number = 1 is allowed to be multiplexed to a |
| | PUSCH |
| 7 | A LP HARQ-ACK is allowed to be multiplexed to a PUSCH |
| . . . | . . . |

Embodiment 4: When UL grant 1 indicates that a HARQ-ACK 1 is allowed to be multiplexed on a PUSCH 1 for transmission, the following conditions shall be met:

that receiving time of the UL grant I is X slots/symbols before the PUCCH 1, where

for example, start time of the UL grant 1 is X1 slots/symbols before start time of the PUCCH 1, or end time of the UL grant 1 is X2 slots/symbols before the start time of PUCCH 1; and

sending time of the PUSCH 1 is Y slots/symbols after the PUCCH 1, where

for example, start time of the PUSCH 1 is Y1 slots/symbols after the end time of the PUCCH 1.

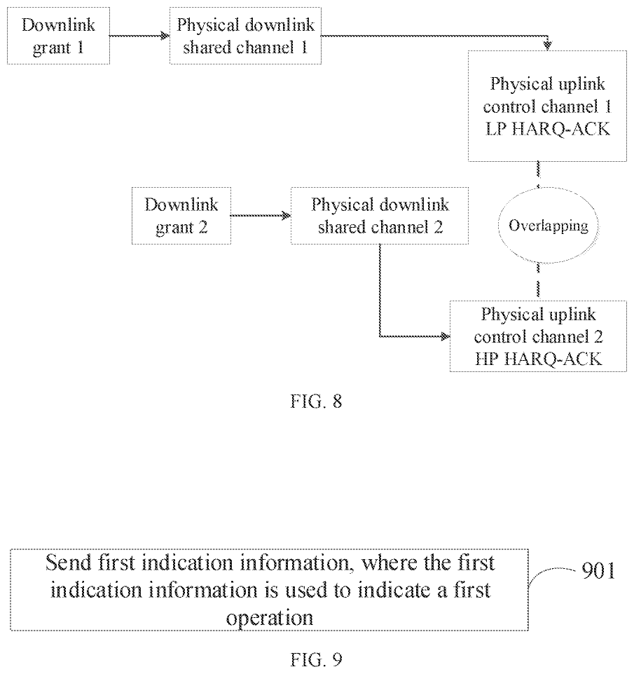

Referring to FIG. 9, FIG. 9 is a flowchart of another HARQ-ACK processing method according to an embodiment of this application. The method is performed by a network device. As shown in FIG. 9, the method includes the following steps.

Step 901: Send first indication information, where the first indication information is used to indicate a first operation.

The first operation includes any one of the following: that a first HARQ-ACK is not multiplexed to a first uplink resource, that some HARQ-ACK in the first HARQ-ACKs is multiplexed to the first uplink resource, and that all HARQ-ACKs in the first HARQ-ACKs are multiplexed to the first uplink resource. The first uplink resource overlaps a first physical uplink control channel PUCCH, and the first PUCCH carries the first HARQ-ACK.

In some implementations, a priority of the first HARQ-ACK is lower than a priority of the first uplink resource.

In some implementations, the first uplink resource includes a second PUCCH or a first physical uplink shared channel PUSCH.

In some implementations, the first uplink resource is a semi-static transmitting uplink resource.

In some implementations, the first HARQ-ACK is a HARQ-ACK corresponding to a semi-persistent scheduling physical downlink shared channel PDSCH, or a HARQ-ACK corresponding to a downlink grant scheduling PDSCH.

in some implementations, in a case that the first operation includes that some HARQ-ACK in the first HARQ-ACKs is multiplexed to the first uplink resource, the some HARQ-ACK corresponds to a target object, where the target object includes at least one of the following:

a PDSCH in at least one PDSCH group;

PDSCHs of M HARQ processes, where the M is a positive integer; and

at least one PDSCH before the first indication information is received.

In some implementations, the method further includes:

sending second indication information, where the second indication information is used to indicate discarding or delaying sending a target HARQ-ACK, where the target HARQ-ACK is a HARQ-ACK in the first HARQ-ACK that is not multiplexed to the first uplink resource.

In some implementations, the delaying sending a target HARQ-ACK includes:

sending the target HARQ-ACK on a second uplink resource, where the second uplink resource is located behind a first object, and the first object includes at least one of the first PUCCH and the first uplink resource.

In some implementations, the second uplink resource includes a PUCCH or a PUSCH,

In some implementations, the second uplink resource is a PUCCH or a PUSCH nearest to the first object.

In some implementations, the second uplink resource is a dynamic scheduling or semi-static configuration uplink resource.

It should be noted that this embodiment is used as an implementation of a network device corresponding to the embodiment shown in FIG. 2. For a specific implementation of this embodiment, refer to related descriptions of the embodiment shown in FIG. 2. To avoid repetition, details are not described herein again.

It should be noted that an execution body of the HARQ-ACK processing method provided in this embodiment of this application may be a HARQ-ACK processing apparatus, or a control module in the HARQ-ACK processing apparatus used for performing the HARQ-ACK processing method. In this embodiment of this application, the HARQ-ACK processing apparatus provided in this embodiment of this application is described by using an example in which the HARQ-ACK processing apparatus preforms the HARQ-ACK processing method.

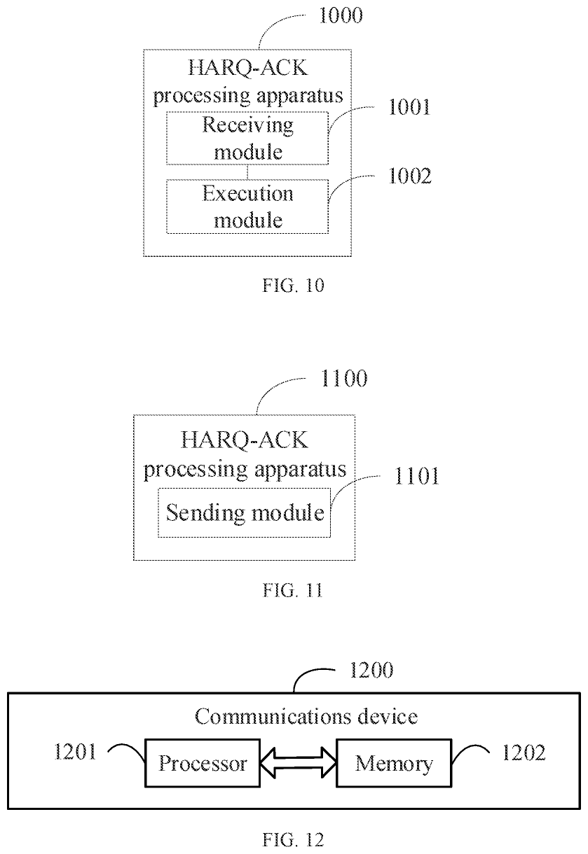

Referring to FIG. 10, FIG. 10 is a structural diagram of a HARQ-ACK processing apparatus according to an embodiment of this application. As shown in FIG. 10, the HARQ-ACK processing apparatus 1000 includes:

a receiving module 1001, configured to receive first indication information sent by a network device, where the first indication information is used to indicate a first operation; and

an execution module 1002, configured to, in a case that a first physical uplink control channel PUCCH overlaps a first uplink resource, perform the first operation.

The first PUCCH carries a first HARQ-ACK. The first operation includes any one of the following: that the first HARQ-ACK is not multiplexed to the first uplink resource, that some HARQ-ACK in the first HARQ-ACKs is multiplexed to the first uplink resource, and that all HARQ-ACKs in the first HARQ-ACKs are multiplexed to the first uplink resource.

In some implementations, a priority of the first HARQ-ACK is lower than a priority of the first uplink resource.

In some implementations, the first uplink resource includes a second PUCCH or a first physical uplink shared channel PUSCH.

In some implementations, the first uplink resource is a semi-static transmitting uplink resource.

In some implementations, the first HARQ-ACK is a HARQ-ACK corresponding to a semi-persistent scheduling physical downlink shared channel PDSCH, or a HARQ-ACK corresponding to a downlink grant scheduling PDSCH.

In some implementations, in a case that the first operation includes that all HARQ-ACKs in the first HARQ-ACKs are multiplexed to the first uplink resource, the receiving module 1001 is further configured to compress the first HARQ-ACK by using a preset compression method.

The preset compression method includes at least one of the following: a time domain compression method, a frequency domain compression method, and a spatial domain compression method.

In some implementations, in a case that the first operation includes that some HARQ-ACK in the first HARQ-ACKs is multiplexed to the first uplink resource, the some HARQ-ACK corresponds to a target object, where the target object includes at least one of the following:

a PDSCH in at least one PDSCH group;

PDSCHs of M HARQ processes, where the M is a positive integer; and

at least one PDSCH before the first indication information is received.

In some implementations, in a case that the first operation is that the first HARQ-ACK is not multiplexed to the first uplink resource or that some HARQ-ACK in the first HARQ-ACKs is multiplexed to the first uplink resource, the execution module 1002 is further configured to discard or delay sending a target HARQ-ACK, where the target HARQ-ACK is a HARQ-ACK in the first HARQ-ACK that is not multiplexed to the first uplink resource.

In some implementations, the receiving module 1001 is further configured to receive second indication information sent by the network device, where the second indication information is used to indicate discarding or delaying sending the target HARQ-ACK.

In some implementations, the delaying sending a target HARQ-ACK includes:

sending the target HARQ-ACK on a second uplink resource, where the second. uplink resource is located behind a first object, and the first object includes at least one of the first PUCCH and the first uplink resource.

In some implementations, the second uplink resource includes a PUCCH or a PUSCH.

In some implementations, the second uplink resource is a PUCCH or a PUSCH nearest to the first object.

In some implementations, the second uplink resource is a dynamic scheduling or semi-static configuration uplink resource.

The network device provided in this embodiment of this application can implement the processes implemented by the terminal in the method embodiment in FIG. 2. To avoid repetition, details are not described herein again.

Referring to FIG. 11, FIG. 11 is a structural diagram of a HARQ-ACK processing apparatus according to an embodiment of this application. As shown in FIG. 11, the HARQ-ACK processing apparatus 1100 includes:

a sending module 1101, configured to send first indication information, where the first indication information is used to indicate a first operation.

The first operation includes any one of the following: that a first HARQ-ACK is not multiplexed to a first uplink resource, that some HARQ-ACK in the first HARQ-ACKs is multiplexed to the first uplink resource, and that all HARQ-ACKs in the first HARQ-ACKs are multiplexed to the first uplink resource. The first uplink resource overlaps a first physical uplink control channel PUCCH, and the first PUCCH carries the first HARQ-ACK.

In some implementations, a priority of the first HARQ-ACK is lower than a priority of the first uplink resource.

In some implementations, the first uplink resource includes a second PUCCH or a first physical uplink shared channel PUSCH.

In some implementations, the first uplink resource is a semi-static transmitting uplink resource.

In some implementations, the first HARQ-ACK is a HARQ-ACK corresponding to a semi-persistent scheduling physical downlink shared channel PDSCH, or a HARQ-ACK corresponding to a downlink grant scheduling PDSCH.

In some implementations, in a case that the first operation includes that some HARQ-ACK in the first HARQ-ACKs is multiplexed to the first uplink resource, the some HARQ-ACK corresponds to a target object, where the target object includes at least one of the following:

a PDSCH in at least one PDSCH group;

PDSCHs of M HARQ processes, where the M is a positive integer; and

at least one PDSCH before the first indication information is received.

In some implementations, the method further includes:

sending second indication information, where the second indication information is used to indicate discarding or delaying sending a target HARQ-ACK, where the target HARQ-ACK is a HARQ-ACK in the first HARQ-ACK that is not multiplexed to the first uplink resource.

In some implementations, the delaying sending a target HARQ-ACK includes:

sending the target HARQ-ACK on a second uplink resource, where the second uplink resource is located behind a first object, and the first object includes at least one of the first PUCCH and the first uplink resource.

In some implementations, the second uplink resource includes a PUCCH or a PUSCH.

In some implementations, the second uplink esource is a PUCCH or a PUSCH nearest to the first object.

In some implementations, the second uplink resource is a dynamic scheduling or semi-static configuration uplink resource.

The terminal provided in this embodiment of this application can implement the processes implemented by the network device in the method embodiments in FIG. 9. To avoid repetition, details are not described herein again.

The HARQ-ACK processing apparatus in this embodiment of this application may be an apparatus, or a component, an integrated circuit, or a chip in a terminal. The apparatus may be a mobile terminal, or a non-mobile terminal. For example, the mobile terminal may include, but is not limited to, the types of the foregoing terminals 11. The non-mobile terminal may be a server, a Network Attached Storage (NAS), a personal computer, a television, a teller machine, a self-service machine, and the like. This is not specifically limited in this embodiment of this application.

The HARQ-ACK processing apparatus in this embodiment of this application may be an apparatus with an operating system. The operating system may be an Android operating system, may be an iOS operating system, or may be another possible operating system. This is not specifically limited in this embodiment of this application.

The HARQ-ACK processing apparatus provided in this embodiment of this application can implement the processes implemented in the method embodiments in FIG. 2 to FIG. 9. To avoid repetition, details are not described herein again.

In some implementations, as shown in FIG. 12, an embodiment of this application further provides a communications device 1200, including a processor 1201, a memory 1202, and a program or an instruction stored in the memory 1202 and capable of running on the processor 1201. When the program or the instruction is executed by the processor 1201, the processes of the foregoing HARQ-ACK processing method embodiments are implemented. To avoid repetition, details are not described herein again.

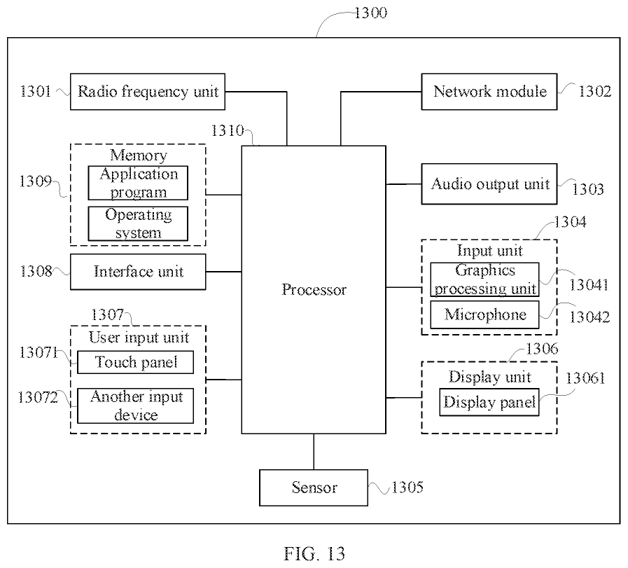

FIG. 13 is a schematic diagram of a hardware structure of a terminal for implementing the embodiments of this application.

The terminal 1300 includes but is not limited to components such as a radio frequency unit 1301, a network module 1302, an audio output unit 1303, an input unit 1304, a sensor 1305, a display unit 1306, a user input unit 1307, an interface unit 1308, a memory 1309, and a processor 1310.

A person skilled in the art can understand that the terminal 1300 may further include a power supply (for example, a battery) that supplies power to the components. The power supply may be logically connected to the processor 1310 by using a power management system, so as to implement functions such as charging management, discharging management, and power consumption management by using the power management system. The terminal structure shown in FIG. 13 constitutes no limitation on the terminal, and the terminal may include more or fewer components than those shown in the figures, or combine some components, or have different component arrangements. Details are not described herein.

It should be understood that, in the embodiments of this application, the input unit 1304 may include a Graphics Processing Unit (GPU) 13041 and a microphone 13042, and the graphics processing unit 13041 processes image data of a still picture or video obtained by an image capture apparatus (such as a camera) in a video capture mode or an image capture mode. The display unit 1306 may include a display panel 13061, and the display panel 13061 may be configured in a form of a liquid crystal display, an organic light-emitting diode, or the like. The user input unit 1307 includes a touch panel 13071 and another input device 13072. The touch panel 13071 is also referred to as a touch screen. The touch panel 13071 may include two parts: a touch detection apparatus and a touch controller. The another input device 13072 may include but is not limited to a physical keyboard, a functional button (such as a volume control button or a power on/off button), a trackball, a mouse, and a joystick. Details are not described herein.

In this embodiment of this application, the radio frequency unit 1301 may, after receiving downlink data from a network device, send the downlink information to the processor 1310 for processing, and in addition, send uplink data to the network device. Generally, the radio frequency unit 1301 includes but is not limited to an antenna, at least one amplifier, a transceiver, a coupler, a low noise amplifier, a duplexer, and the like.

The memory 1309 may be configured to store a software program or an instruction and various data. The memory 109 may mainly include a program or instruction storage area and a data storage area. The program or instruction storage area may store an operating system, and an application or an instruction required by at least one function (for example, a sound playing function or an image playing function). In addition, the memory 1309 may include a high-speed random access memory, or may further include a non-volatile memory. The non-volatile memory may be a Read-Only Memory (ROM), a Programmable ROM (PROM), an Erasable PROM (EPROM), an Electrically EPROM (EEPROM), or a flash memory. For example, at least one disk storage component, a flash memory component, or another non-volatile solid-state storage component.

The processor 1310 may include one or more processing units. In some implementations, an application processor and a modem processor may be integrated into the processor 1310. The application processor mainly processes an operating system, a user interface, an application, an instruction, or the like. The modem processor mainly processes wireless communications, for example, a baseband processor. It can be understood that, alternatively, the modem processor may not be integrated into the processor 1310.

The radio frequency unit 1301 is configured to receive first indication information sent by a network device, where the first indication information is used to indicate a first operation.

The processor 1310 is configured to, in a case that a first Physical Uplink Control CHannel (PUCCH) overlaps a first uplink resource, perform the first operation.

The first PUCCH carries a first HARQ-ACK. The first operation includes any one of the following: that the first HARQ-ACK is not multiplexed to the first uplink resource, that some HARQ-ACK in the first HARQ-ACKs is multiplexed to the first uplink resource, and that all HARQ-ACKs in the first HARQ-ACKs are multiplexed to the first uplink resource.

It should be understood that, in this embodiment, the processor 1310 and the radio frequency unit 1301 can implement the processes implemented by the terminal in the method embodiment in FIG. 2. To avoid repetition, details are not described herein again.

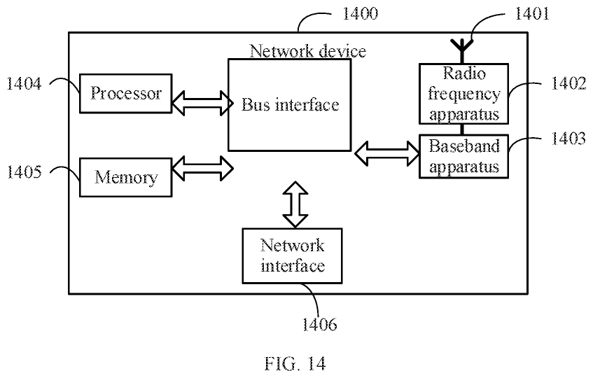

In some implementations, an embodiment of this application further provides a network-side device. As shown in FIG. 14, the network device 1400 includes an antenna 1401, a radio frequency apparatus 1402, and a baseband apparatus 1403. The antenna 1401 is connected to the radio frequency apparatus 1402. In an uplink direction, the radio frequency apparatus 1402 receives information by using the antenna 1401, and sends the received information to the baseband apparatus 1403 for processing. In a downlink direction, the baseband apparatus 1403 processes to-be-sent information, and sends the to-be-sent information to the radio frequency apparatus 1402. After processing the received information, the radio frequency apparatus 1402 sends the information by using the antenna 1401.

The frequency band processing apparatus may be located in the baseband apparatus 1403. The method performed by the network-side device in the above embodiment may be implemented in the baseband apparatus 1403. The baseband apparatus 1403 includes a processor 1404 and a memory 1405.

The baseband apparatus 1403 may include, for example, at least one baseband board, where a plurality of chips are disposed on the baseband board. As shown in FIG. 14, one chip is, for example, the processor 1404, which is connected to the memory 1405, so as to invoke a program in the memory 1405 to perform operations of the network device shown in the above method embodiment.

The baseband apparatus 1403 may further include a network interface 1406, configured to exchange information with the radio frequency apparatus 1402. For example, the interface is a Common Public Radio Interface (CPRI).

In some implementations, the network-side device in this embodiment of this application further includes an instruction or a program that is stored in the memory 1405 and that can run on the processor 1404. The processor 1404 invokes the instruction or the program in the memory 1405 to perform the method performed by the modules shown in FIG. 11. To avoid repetition, details are not described herein.

An embodiment of this application further provides a readable storage medium. The readable storage medium stores a program or an instruction. When the program or the instruction is executed by a processor, the processes in the foregoing method embodiments of the HARQ-ACK processing method are implemented. To avoid repetition, details are not described herein again.

The processor is a processor in the electronic device in the foregoing embodiment. The readable storage medium includes a computer-readable storage medium such as a computer Read-Only Memory (ROM), a Random Access Memory (RAM), a magnetic disk, or an optical disc.

An embodiment of this application further provides a chip. The chip includes a processor and a communications interface, and the communications interface is coupled to the processor. The processor is configured to run a program or an instruction of a network device, to implement various processes of the foregoing HARQ-ACK processing method embodiment. To avoid repetition, details are not described herein again.

It should be understood that the chip mentioned in this embodiment of this application may also be referred to as a system-level chip, a system chip, a system on chip, a system-on-a-chip chip, and the like.

It should be noted that, in this specification, the terms “include,” “comprise,” or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element limited by “includes a . . . ” does not, without more constraints, preclude the presence of additional identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

A person of ordinary skill in the art may recognize that, with reference to the examples described in the embodiments disclosed herein, units and algorithm steps may be implemented by electronic hardware or a combination of computer software and electronic hardware. Whether these functions are implemented by using hardware or software depends on the specific application and design constraints of the technical solution. A person skilled in the art may use different methods to implement the described functions for each particular application, but it should not be considered that the implementation goes beyond the scope of the present disclosure.

It may be clearly understood by a person skilled in the art that, for convenience and brevity of description, for a specific working process of the above described system, apparatus, and unit, reference may be made to a corresponding process in the above method embodiments, and details are not described herein again.

In the embodiments provided in this application, it should be understood that the disclosed apparatus and method may be implemented in another manner. For example, the described apparatus embodiment is merely an example. For example, the unit division is merely logical function division. In actual implementation, there may be another division manner. For example, multiple units or components may be combined or integrated into another system, or some features may be ignored or not performed. In addition, the displayed or discussed mutual coupling or direct coupling or communication connection may be through some interfaces, indirect coupling or communication connection of the apparatus or unit, and may be in an electrical, mechanical, or another form.

The units described as separate parts may or may not be physically separate, and parts displayed as units may or may not be physical units, may be located in one place, or may be distributed on multiple network units. Some or all of the units may be selected based on an actual requirement to implement the objectives of the solutions in the embodiments,

In addition, functional units in the embodiments of the present disclosure may be integrated into one processing unit, or each of the units may exist alone physically, or two or more units are integrated into one unit,

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially, or the part contributing to the prior art may be implemented in a form of a software product. The software product is stored in a storage medium (for example, ROM/RAM, a magnetic disk, or an optical disc), and includes several instructions for instructing a terminal (which may be a mobile phone, a computer, a server, an air conditioner, a base station, or the like) to perform the method described in the embodiments of the present application.

It can be understood that the embodiments described in the present disclosure may be implemented by hardware, software, firmware, middleware, microcode, or a combination thereof. For hardware implementation, a module, a unit, a subunit, or the like may be implemented in one or more Application Specific Integrated Circuits (ASIC), a Digital Signal Processor (DSP), a DSP Device (DSPD), a Programmable Logic Device (PLD), a Field-Programmable Gate Array (FPGA), a general purpose processor, a controller, a microcontroller, a microprocessor, another electronic unit configured to perform the functions described in the present disclosure, or a combination thereof.

For implementation with software, technologies described in the embodiments of the present disclosure may be implemented by executing functional modules (for example, a process and a function) in the embodiments of the present disclosure. A software code may be stored in the memory and executed by the processor. The memory may be implemented in the processor or outside the processor.

The embodiments of the present application are described above with reference to the accompanying drawings, but the present application is not limited to the foregoing specific implementations. The foregoing specific implementations are merely schematic instead of restrictive. Under enlightenment of the present application, a person of ordinary skills in the art may make many forms without departing from aims and the protection scope of claims of the present application, all of which fall within the protection scope of the present application.

1. A Hybrid Automatic Repeat reQuest ACKnowledgment (HARQ-ACK) processing method, performed by a terminal, wherein the method comprises:
receiving first indication information sent by a network device, wherein the first indication information is used to indicate a first operation; and
in a case that a first Physical Uplink Control CHannel (PUCCH) overlaps a first uplink resource, performing the first operation;
wherein the first PUCCH carries a first HARQ-ACK, and the first operation comprises any one of the following: that the first HARQ-ACK is not multiplexed to the first uplink resource, that one or more HARQ-ACKs in the first HARQ-ACKs are multiplexed to the first uplink resource, and that all HARQ-ACKs in the first HARQ-ACKs are multiplexed to the first uplink resource.

2. The method according to claim 1, wherein a priority of the first HARQ-ACK is lower than a priority of the first uplink resource.

3. The method according to claim 1, wherein the first uplink resource comprises a second PUCCH or a first Physical Uplink Shared CHannel (PUSCH).

4. The method according to claim 1, wherein the first uplink resource is a semi-static transmitting uplink resource.

5. The method according to claim 1, wherein the first HARQ-ACK is a HARQ-ACK corresponding to a semi-persistent scheduling Physical Downlink Shared CHannel (PDSCH), or a HARQ-ACK corresponding to a downlink grant scheduling PDSCH.

6. The method according to claim 1, wherein in a case that the first operation comprises that all HARQ-ACKs in the first HARQ-ACKs are multiplexed to the first uplink resource, the method further comprises:
compressing the first HARQ-ACK by using a preset compression method,
wherein the preset compression method comprises at least one of the following:
a time domain compression method, a frequency domain compression method, or a spatial domain compression method.

7. The method according to claim 1, wherein in a case that the first operation comprises that one or more HARQ-ACKs in the first HARQ-ACKs are multiplexed to the first uplink resource, the one or more HARQ-ACKs correspond to a target object, wherein the target object comprises at least one of the following:
a PDSCH in at least one PDSCH group;
PDSCHs of M HARQ processes, wherein the M is a positive integer; or
at least one PDSCH before the first indication information is received.

8. The method according to claim 1, wherein in a case that the first operation is that the first HARQ-ACK is not multiplexed to the first uplink resource or that one or more HARQ-ACKs in the first HARQ-ACKs are multiplexed to the first uplink resource, the method further comprises:
discarding or delaying sending a target HARQ-ACK, wherein the target HARQ-ACK is a HARQ-ACK in the first HARQ-ACK that is not multiplexed to the first uplink resource.

9. The method according to claim 8, wherein before discarding or delaying sending a target HARQ-ACK, the method further comprises:
receiving second indication information sent by the network device, wherein the second. indication information is used to indicate discarding or delaying sending the target HARQ-ACK.

10. The method according to claim 8, wherein the delaying sending a target HARQ-ACK comprises:
sending the target HARQ-ACK on a second uplink resource, wherein the second uplink resource is located behind a first object, and the first object comprises at least one of the first PUCCH or the first uplink resource.

11. The method according to claim 10, wherein the second uplink resource comprises a PUCCH or a PUSCH, the second uplink resource is a PUCCH or a PUSCH nearest to the first object.

12. The method according to claim 10, wherein the second uplink resource is a dynamic scheduling or semi-static configuration uplink resource.

13. A Hybrid Automatic Repeat reQuest ACKnowledgment (HARQ-ACK) processing method, performed by a network device, wherein the method comprises:
sending first indication information, wherein the first indication information is used to indicate a first operation,
wherein the first operation comprises any one of the following: that a first HARQ-ACK is not multiplexed to a first uplink resource, that one or more HARQ-ACKs in the first HARQ-ACKs are multiplexed to the first uplink resource, and that all HARQ-ACKs in the first HARQ-ACKs are multiplexed to the first uplink resource, wherein the first uplink resource overlaps a first Physical Uplink Control CHannel (PUCCH), and the first PUCCH carries the first HARQ-ACK.

14. The method according to claim 13, wherein a priority of the first HARQ-ACK is lower than a priority of the first uplink resource.

15. The method according to claim 13, wherein the first uplink resource comprises a second PUCCH or a first Physical Uplink Shared CHannel (PUSCH).

16. The method according to claim 13, wherein the first uplink resource is a semi-static transmitting uplink resource.

17. The method according to claim 13, wherein the first HARQ-ACK is a HARQ-ACK corresponding to a semi-persistent scheduling Physical Downlink Shared CHannel (PDSCH), or a HARQ-ACK corresponding to a downlink grant scheduling PDSCH.

18. The method according to claim 13, wherein in a case that the first operation comprises that one or more HARQ-ACKs in the first HARQ-ACKs are multiplexed to the first uplink resource, the one or more HARQ-ACKs correspond to a target object, wherein the target object comprises at least one of the following:
a PDSCH in at least one PDSCH group;
PDSCHs of M HARQ processes, wherein the M is a positive integer; or
at least one PDSCH before the first indication information is received.

19. The method according to claim 13, further comprising:
sending second indication information, wherein the second indication information is used to indicate discarding or delaying sending a target HARQ-ACK, wherein the target HARQ-ACK is a HARQ-ACK in the first HARQ-ACK that is not multiplexed to the first uplink resource.

20. The method according to claim 19, wherein the delaying sending a target HARQ-ACK comprises:
sending the target HARQ-ACK on a second uplink resource, wherein the second uplink resource is located behind a first object, and the first object comprises at least one of the first PUCCH or the first uplink resource.
